(19) United States
(12) Patent Application Publication
(10) Pub. No.: US 2010/0288957 A1
(43) Pub. Date: Nov. 18, 2010

(54) SHUT-OFF SYSTEM HAVING A PIVOT FLAP FOR LARGE PIPE CROSS-SECTIONS

(75) Inventor: Hans-Jürgen Janich, Grub am Forst (DE)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(73) Assignee: Janich GmbH & Co. KG

(21) Appl. No.: 12/775,081

(22) Filed: May 6, 2010

(30) Foreign Application Priority Data
May 12, 2009 (DE) 10 2009 020 843.7

(51) Int. Cl. F16K 1/22

(52) U.S. Cl. 251/305

(57) ABSTRACT

The shut-off system for large pipe cross-sections comprises a flap housing which is provided with pipe connections, a pivot flap which can be pivoted back and forth therein between two end positions and a drive device having a drive shaft which is connected to the pivot flap by means of a toggle lever system, the drive shaft being constructed in the manner of a lattice tower.

### TECHNICAL FIELD OF THE INVENTION

The invention relates to a shut-off system for large pipe cross-sections having a flap housing which is provided with pipe connections and a pivot flap which can be pivoted back and forth therein between two end positions.

### BACKGROUND OF THE INVENTION

Shut-off systems of this type are used in particular in gas turbine systems and flue gas purification systems. In order to achieve a gas-tight closure, the large plate must be pressed in the shut-off position with high pressure against the stationary sealing face. Furthermore, in the end positions, high differential pressures also have to be overcome. In DE 10 2007 016 554 A1, DE 38 73 509 T2, DE 40 30 611 A1 and DE 33 18 202 A1, there are used, in order to pivot the flap, toggle lever systems which have been found to be particularly suitable since high closure forces can be produced with relatively low drive torques in the end positions of the pivot flap owing to the effect of the toggle lever.

When a toggle lever is used, it is advantageous to arrange the drive shaft as close as possible to the centre of the pivot flap since the action of the toggle lever in the end positions is best exploited in this manner and the closure force is approximately equal at the periphery of the pivot flap.

However, this arrangement of the drive shaft has, in one of the end positions, the disadvantage that the cross-section of the pipe connection is correspondingly narrowed by the drive shaft and the toggle lever system so that this cross-section loss must be compensated for by a correspondingly higher energy requirement of the gas ventilator. In one of the end positions, hot gas is further applied to one side of the hollow shaft so that there may consequently result substantial tension differences leading to deformation of the shaft, which in turn may lead to malfunction or blocking of the drive.

### SUMMARY OF THE INVENTION

An object of the invention is therefore to set out a shut-off system for large pipe cross-sections which is distinguished by a smaller cross-section loss.

According to the invention, this object is achieved by the features of claim 1.

The shut-off system according to the invention for large pipe cross-sections substantially comprises a flap housing which is provided with pipe connections, a pivot flap which can be pivoted back and forth therein between two end positions and a drive device having a drive shaft which is connected to the pivot flap by means of a toggle lever system, the drive shaft being constructed in the manner of a lattice tower.

In this manner, gas is able to flow through the drive shaft so that the cross-section loss with the pivot flap open is reduced by approximately from 10 to 20% compared with a hollow shaft configuration. Accordingly, there is also a correspondingly lower energy requirement for the gas ventilator. Constructing the drive shaft in the manner of a lattice tower further has the advantage that the drive shaft can be produced from readily available standard material in a significantly cheaper manner than the hollow shafts previously used.

However, the ability of the drive shaft to allow flow not only reduces the cross-section loss but also allows very uniform warming of the drive shaft by the gases which are often very hot so that tension differences and in particular deformation of the shaft can be prevented.

The dependent claims relate to other configurations of the invention.

According to one configuration of the invention, the drive shaft extends in one end position of the pivot flap transversely over the pipe cross-section and a gas which flows through the pipe connection flows through it. Furthermore, the toggle lever system may also comprise at least one toggle lever which is also constructed in the manner of a lattice tower. In this manner, the cross-section loss can be further reduced.

The drive shaft which is constructed in the manner of a lattice tower or the correspondingly constructed toggle lever preferably have an angular, in particular square, cross-section. A shaft journal is retained at each of the two ends of the drive shaft which is constructed in the manner of a lattice tower, which journals are arranged in the flap housing.

### DESCRIPTION OF THE DRAWINGS

Other advantages and configurations of the invention are explained in greater detail below with reference to the description and the drawings, in which:

FIG. 1 is a three-dimensional illustration of the shut-off system and

FIG. 2 is an enlarged three-dimensional illustration of the drive shaft with toggle lever system.

### DETAILED DESCRIPTION OF THE DRAWINGS

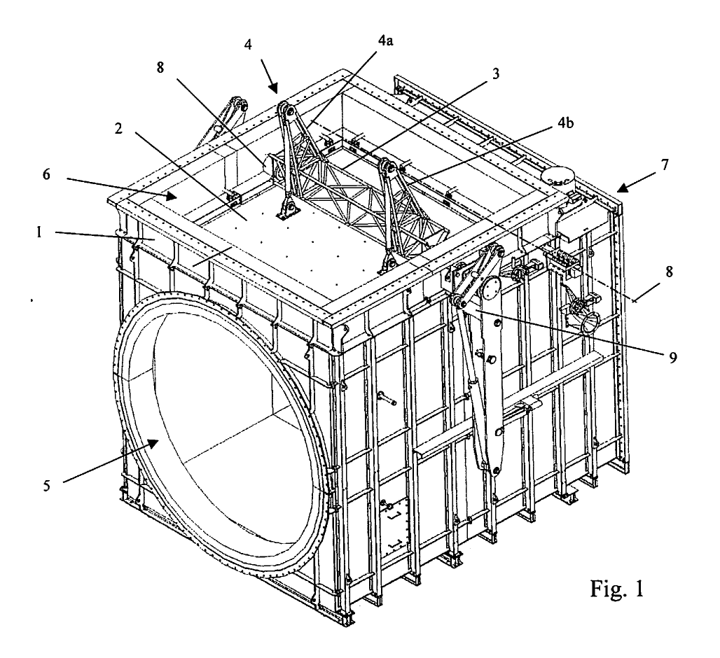

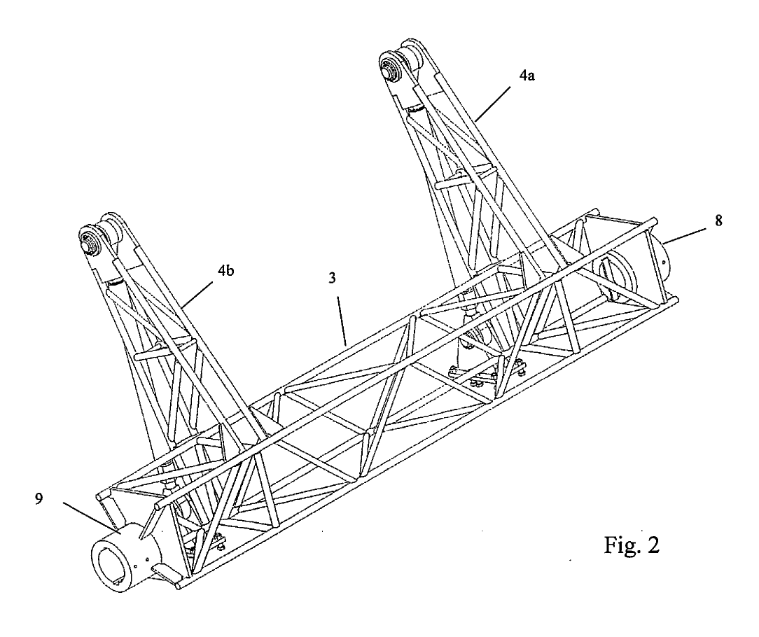

The shut-off system illustrated in FIGS. 1 and 2 for large pipe cross-sections substantially comprises a flap housing 1, a pivot flap 2 and a drive device having a drive shaft 3 which is connected to the pivot flap by means of at least one toggle lever system 4. The pivot flap 2 is supported for rotation about a pivot axis 8, which is indicated with dot-dash lines, so that a rotational movement of the drive shaft 3 brings about pivoting of the pivot flap 2 about the pivot axis 8 via the toggle lever system.

The flap housing 1 is provided with three pipe connections 5, and 7, the pivot flap 3 selectively closing the pipe connection 6 (see FIG. 1) or the pipe connection 7.

The drive shaft 3 is constructed in the manner of a lattice tower, this being able in particular to be a tubular grid construction. However, the lattice construction may also be formed, for example, from angular profile-members (for example, L-shaped or T-shaped carriers). The drive shaft 3 extends in the embodiment illustrated transversely over the clear cross-section of the pipe connection 6, there being retained at each of the ends thereof shaft journals 8, 9 which are each arranged in a suitable bearing of the flap housing 1.

The pivot flap 2 co-operates in both end positions with appropriately formed sealing elements which may be constructed in particular in accordance with EP-B1-1 092 899, the entirety of which is incorporated herein by reference. When the present application refers to a shut-off system for large pipe cross-sections, pipe cross-sections of more than 15 m², in particular more than 20 m², or more than 40 m², are intended to be referred to.

If the pivot flap 2 is in the closure position of the pipe connection 7 (not illustrated), gas which enters via the pipe connection 5 and which is discharged from the pipe connection 6 flows through the drive shaft 3.

The rotational movement of the drive shaft 3 is transmitted to the pivot flap 2 in the embodiment illustrated by two toggle lever systems 4 which each comprise two toggle levers. At least the toggle levers 4a, 4b which are connected to the drive shaft 3 are also constructed in the manner of a lattice tower. In this manner, the cross-section loss in the opening position of the pipe connection 6 can be further reduced.

The rotational movement of the drive shaft 3 is brought about by means of an appropriate drive mechanism 9, which is described in greater detail, for example, in EP 1 978 304 A1, the entirety of which is incorporated herein by reference.

The drive shaft 3 and the toggle levers 4a, 4b advantageously have an angular cross-section, particular consideration being given to a square, a rectangular, a triangular or a polygonal cross-section. The angular cross-sectional shape has a very high degree of stability and allows a very simple and rotationally secure connection of the toggle levers 4a, 4b to the drive shaft 3.

1. Shut-off system for large pipe cross-sections having a flap housing which is provided with pipe connections, and a pivot flap which can be pivoted back and forth therein between two end positions and a drive device having a drive shaft which is connected to the pivot flap by means of a toggle lever system,
characterised in that the drive shaft is constructed in the manner of a lattice tower.

2. Shut-off system according to claim 1, characterised in that the drive shaft extends in one end position of the pivot flap transversely over the pipe cross-section and a gas which flows through the pipe connection is able to flow through it.

3. Shut-off system according to claim 1, characterised in that the toggle lever system comprises at least one toggle lever which is also constructed in the manner of a lattice tower.

4. Shut-off system according to claim 1, characterised in that the toggle lever system comprises at least a first toggle lever which is connected in a rotationally secure manner to the drive shaft and a second toggle lever which is connected in an articulated manner thereto and to the pivot flap.

5. Shut-off system according to claim 1, characterised in that the drive shaft which is constructed in the manner of a lattice tower has an angular, in particular square, cross-section.

6. Shut-off system according to claim 1, characterised in that a shaft journal is retained at each of the two ends of the drive shaft which is constructed in the manner of a lattice tower.
